(19) United States
(12) Patent Application Publication
(10) Pub. No.: US 2009/0127883 A1
(43) Pub. Date: May 21, 2009

(54) Automobile Surface Protector Having Adjustable Width

(76) Inventor: Graeme Breen, Brisbane (AU)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/086,849

(22) PCT Filed: Dec. 20, 2006
(86) PCT No.: PCT/AU2006/001943

§ 371 Date: Nov. 21, 2008

(30) Foreign Application Priority Data
Dec. 21, 2005 (AU) 2005907206

(51) Int. Cl. B60R 13/01

(52) U.S. Cl. 296/39.1

(57) ABSTRACT

A surface protector for the cargo area of a vehicle. The protector includes a roller assembly formed by a pair of tubular slides, one received in the other, so that the length of the roller assembly can be adjusted. Flexible sheets are attached to the slides and are able to move with respect to each other during adjustment of the length of the roller assembly. This provides a corresponding adjustment of the width covered by the sheets. The slides are mounted on a mounting assembly which includes feet to bear against opposing walls of a vehicle cargo area.

### FIELD OF THE INVENTION

The present invention relates to an automobile surface protector that is mountable in an automobile cargo area. In particular the present invention relates to a protector for an internal and/or external surface of an automobile in the vicinity of the cargo area so that the surface is protected from damage when loading and unloading the cargo area.

### BACKGROUND TO THE INVENTION

Automobile cargo area protectors protect the cargo area from dirt or damage caused by items or animals that are placed or transported in the cargo area. Some of these protectors have a retractable protective sheet which is able to extend over the rear section of the automobile to protect the bumper, or rear panel, as well as at least part of the cargo area to protect the rear surface of the automobile from dirt or damage. Currently many cargo area protectors, or automotive surface protectors, are permanently mounted, or at least a portion of the mounting assembly is permanently affixed, in the cargo area or an adjacent area. However, with the cargo area protector permanently attached to the automobile, the cargo area protector is not suitable for use in other automobiles.

Some cargo area protectors are removably mounted in the cargo area, however, the width of the protective element or sheet is fixed. These cargo area protectors are not suitable for a range of automobiles having significantly different cargo area widths. Further the width of the cargo area and the cargo area opening can be significantly different, such that a cargo area protector is generally only suitable for one automobile or a small number of automobiles.

### SUMMARY OF THE INVENTION

It is an object of the invention to provide an automobile surface protector that is removable and is able to suitably cover the surface of a large number of automobiles having different cargo area widths and cargo area opening widths.

In one aspect, the present invention provides an automobile surface protector removably mountable in an automobile cargo area, said protector including a roller assembly formed by an outer tubular slide and an inner tubular slide received in the outer slide so that the length of the roller assembly can be selectively adjusted, a first flexible protective sheet attached to said outer slide and a second flexible protective sheet attached to said inner slide whereby the first flexible sheet and second flexible sheet slide with respect to each other during adjustment of the length of the roller assembly to provide corresponding adjustment of the width covered by the first flexible sheet and second flexible sheet, a mounting assembly to mount the outer and inner slides, said mounting assembly including feet at each end of the mounting assembly to respectively bear against opposing walls of a vehicle cargo area.

The surface protector of the present invention is removably mounted to the automobile cargo area so that it is able to be mounted in a number of different automobiles. In addition, as the width of the two sheets is variable, the surface protector is able to suitably cover an even greater number of different automobiles with the one surface protector. As such the surface protector of the present invention is able to be used with a large number of automobiles without modifications to the existing cargo area of the automobile.

A further advantage of the present invention is that the automobile surface protector is mounted in the cargo area of the automobile without any permanent fixations or modifications to the existing cargo area. Preferably, in one embodiment, the protective sheets are of sufficient length so as to extend over the automobile surface and a substantial portion of the cargo area floor. This enables the automobile protective sheet to protect the cargo area floor as well as the automobile surface.

Preferably the mounting assembly provides for rotation of the inner and outer slides to effect winding and unwinding of the first flexible sheet and second flexible sheet so that the first flexible sheet and the second flexible sheet can be overlappingly wound about the roller assembly. This provides for a compact arrangement when not in use. Even more preferably, the mounting assembly forms an axle.

Preferably, the protective sheets are made from a thin, tear resistant material that is water impermeable and has low co-efficient of surface friction. It will be appreciated that the sheets can be made from any suitable material, for example polyethylene, polypropylene, acrylic.

Preferably, the mounting assembly is adjustable in length and the retaining means securely holds the mounting assembly at the desired length so that the feet bear against the wall of the cargo area. Even more preferably, the mounting assembly is formed from at least two tubular components. Preferably, the first tubular component is nested within the second tubular component to form a telescopic arrangement. In the preferred embodiment, the mounting assembly forms an axle extending through the roller assembly about which the roller assembly rotates. In this form of the invention, the length of the mounting assembly and the length of the roller assembly are independently adjusted.

In one embodiment, the automobile surface protector includes a biasing means to bias the protective slides towards a wound position. In this embodiment the protective sheets attached to the slides are automatically wound onto the slides when not in use and for storage.

It is also possible that a protector device having a structure as defined above could be used in other environments requiring a sheet of variable width, such as a shade for a range of window sizes for example.

### LIST OF FIGURES

Preferred embodiments will now be further described, by way of example only, with reference to the accompanying drawings in which:

FIG. 1 is a plan view through a cross-section of a surface protector according to one embodiment of the invention.

FIG. 2 is a cross section through section A-A of FIG. 1, where the protective sheets are in a retracted position.

FIG. 3 is a cross section through section A-A of FIG. 1, where the protective sheets are in an extended position.

FIG. 4 shows the automobile surface protector of FIG. 1 installed in the cargo area of an automobile.

FIG. 5 shows an alternative installation of the automobile surface protector of FIG. 1 in the cargo area of an automobile.

### DESCRIPTION OF PREFERRED EMBODIMENTS

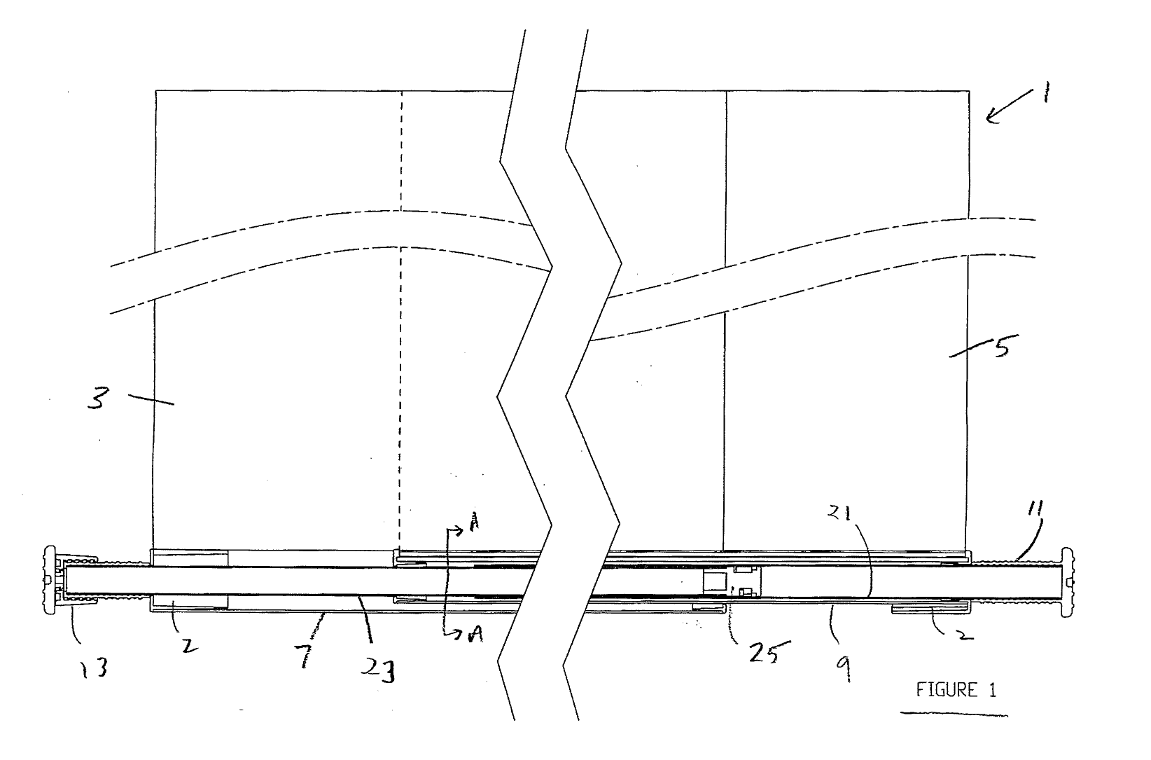

Referring to FIGS. 1 to 3, the automobile surface protector 1 has two flexible protective sheets 3, 5 which are able to extend over the rear or front of the automobile to protect the surface of the automobile from damage during loading and unloading of the cargo area. The two protective sheets 3, 5 overlap so as to enable the automobile surface protector 1 to cover a variety of different widths without need for changing the protective sheets 3, 5.

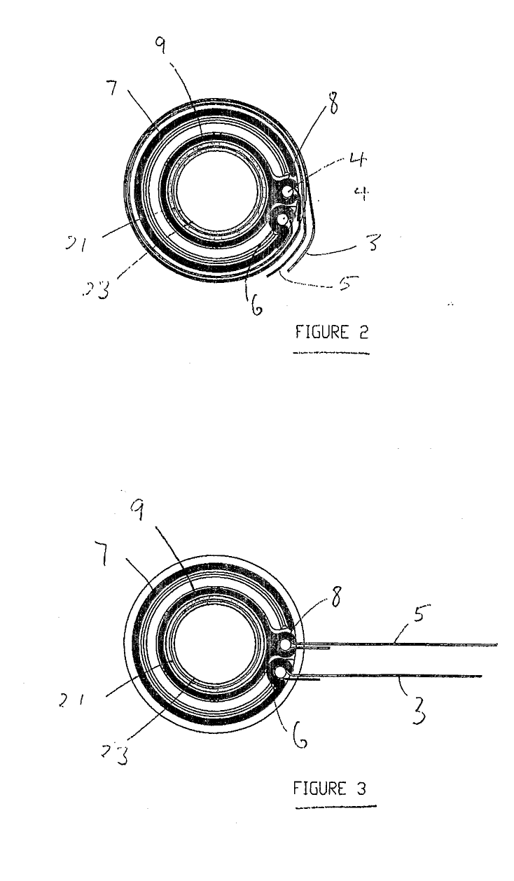

The protector 1 includes a roller assembly formed by an outer tubular slide 7 and an inner tubular slide 9 nestingly received in the outer slide 7 so that the length of the roller assembly can be selectively adjusted. The first flexible protective sheet 3 is attached to the outer slide 7 and the second flexible protective sheet 5 is attached to the inner slide 9 so that the sheets 3, 5 are able to be rolled onto the roller assembly for storage when not in use (see FIG. 2) and rolled from the roller assembly for use (see FIG. 3). The slides are typically formed from a relatively rigid material, such as aluminium sheets, and may be shaped by roll forming or extrusion for example.

A longitudinal slot 6 is provided on the outer slide 7 to fasten one edge of sheet 3 to the slide. Similarly a slot 8 is provided on the inner slide 9 to fasten one edge of sheet 5. Strips 4 are fitted into the slots 6, 8 to capture the edges of the sheets 3 and 5 respectively. Slot 8 protrudes into a longitudinal opening in the outer slide 7 to allow for the overlapping portion of the second protective sheet 5 attached to the inner slide 9 to pass through the outer slide.

The slots may be formed in many ways, and are typically integral with the respective slide. In this example, outer slide 7 has a cylindrical surface with a narrow opening along a line on one side, and slot 6 is formed from one edge of the opening. Inner slide 9 is also a tube, but with a continuous cylindrical surface, and slot 8 is formed as a protrusion from the surface. Slot 6 extends inwards toward slide 9 while slot 8 extends outwards toward slide 7. The slots are nested adjacent to each other and do not extend beyond the surface of the outer slide, so that the protective sheets can be rolled smoothly around the roller assembly when not in use.

The first flexible sheet 3 and second flexible sheet 5 are thin, tear resistant material that is water impermeable and has a low co-efficient of surface friction. The low co-efficient of surface friction allows the sheets 3, 5 to easily slide with respect to each other during adjustment of the length of the roller assembly to provide corresponding adjustment of the width of the surface covered by the first flexible sheet 3 and second flexible sheet 5. This enables the automobile surface protector 1 to be used with a variety of automobiles whilst providing an adequate coverage of the automobile surface to be protected. Advertising may be located on the flexible sheets by the manufacturer of the surface protector.

The outer slide 7 and inner slide 9 are mounted on a mounting assembly so that the protective sheets 3, 5 can be wound and unwound from the roller assembly. The mounting assembly includes feet 11, 13 at each end to respectively bear against opposing walls of a vehicle cargo area and a retaining means to force the feet 11, 13 apart against the opposing walls to removably secure the protector 1 in position in the cargo area. The feet may be adapted for attachment or location on fittings which are already present in the cargo area, or on other structures depending on the environment in which the protector is used. For example, each foot may include an aperture which receives a spigot from an associated clamping device.

The mounting assembly takes the form of an axle formed from a telescopic arrangement including an outer tube 21, an inner tube 23 nested in the outer tube 21, and an tube locking mechanism 25 to securely retain the tubes at selected lengths. The locking mechanism 25 is a cam locking arrangement of a known type which locks and unlocks by relative twisting. Bearings 2 are structured to hold the slides 7, 9 and tubes 21, 23 in fixed axial relation to one another.

Feet in the form of end caps 11, 13 are attached to the outer ends of each tube to bear against the walls of the cargo area. The feet allow the automobile surface protector to be installed in a cargo area without any modification of permanent fixtures. The end cap 13 is attached to the inner tube 23 by a screw thread so as to further adjust the overall length of the mounting assembly to secure the surface protector to the cargo area.

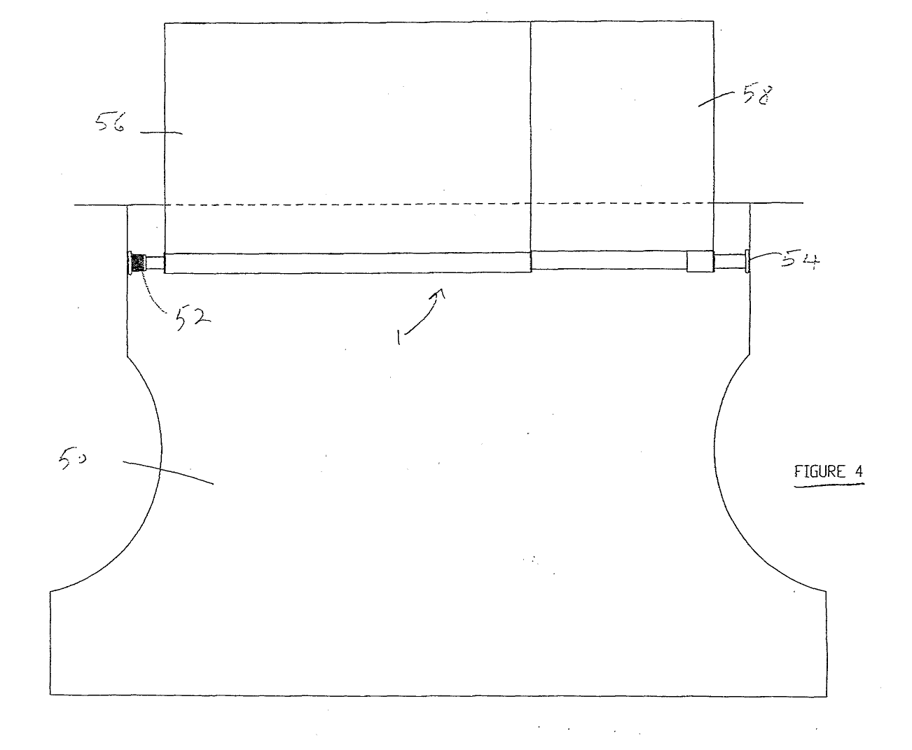

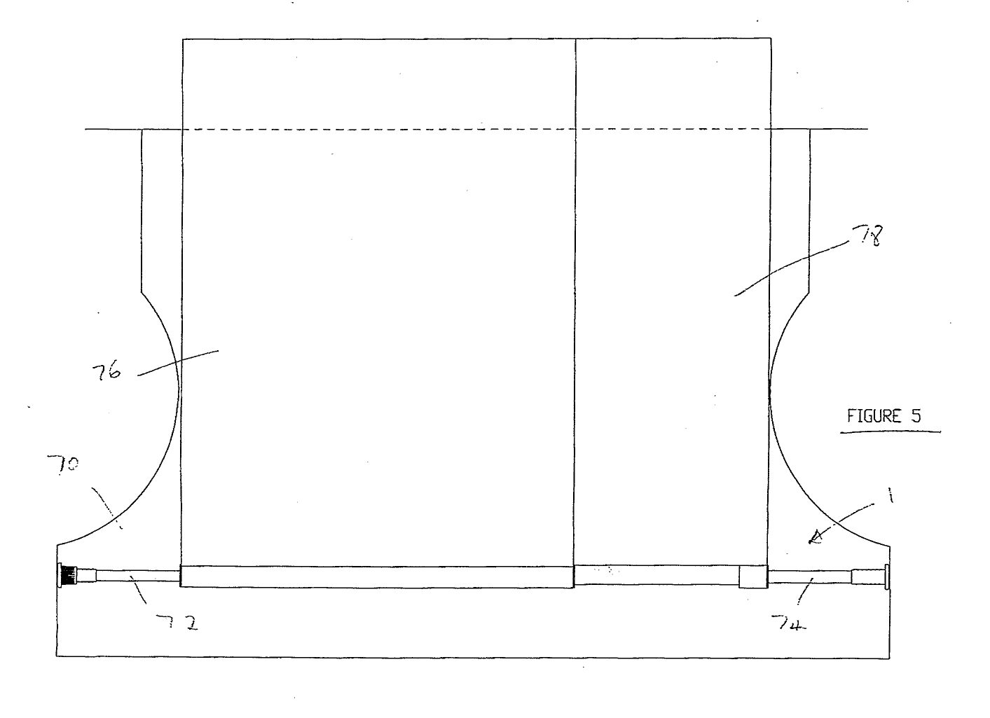

As shown in FIG. 4, the automobile surface protector 1 is installed in the cargo area 50 for use. The feet 52, 54 are securely retained against the wall of the cargo area 50 by extending the telescopic mounting assembly so that the end caps are adjacent the walls of the cargo area and securing the mounting assembly in the extended position. An end cap is rotated so as to further extend the overall length of the telescopic mounting assembly so as to clamp the automobile surface protector to the cargo area.

In this installed position, the relative position of the roller assembly, and thereby the protective sheets 56, 58, with respect to the cargo area opening can be changed to suit the particular automobile by sliding the inner and outer slides along the mounting assembly. Once the protective sheets are extended, the inner and outer slides can then be moved relative to each other to adjust the width of the protective sheets to suit the particular automobile so that the automobile surface is suitably covered to provide adequate protection to the automobile surface from unloading and loading the cargo area. In this arrangement, the automobile surface protector is sufficiently adjustable and transportable so as to be suitable for use in a large number of automobiles with the single product.

When the protective sheets 56, 58 are not required to be extended over the automobile surface, the sheets can be wound onto the slides by rotating the slides. Alternatively the sheets in their unwound state can be rotated about the mounting assembly to be fully housed within the cargo area. The automobile surface protector may also have a retaining device, such as one or more velcro straps or strings, to retain the protective sheets in their wound position on the slides of the protector. If desired, the automobile surface protector can be removed completely from the cargo area when not required by releasing the mounting.

Although not shown, a biasing means can be attached to one of the inner or outer slides or both slides so that the protective sheets are automatically wound onto the slides. In one embodiment a first coil spring is attached to the outer slide to bias the slides to a position where the protective sheets are wound on the slides. In an alternative embodiment, a second coil spring is attached to the inner slide to bias the slides to a position where the protective sheets are wound on the slides.

A locking means, such as a latch, can be included to selectively lock the slides in positions relative to the mounting assembly. The locking means can then lock the protective sheets 56, 58 in a wound position, a completely unwound position or an intermediate position. This is especially desirable when the biasing means is included so that the protective sheets can be unwound to a particular length and locked in that position without the biasing means winding the sheets onto the slides.

An alternative installation is shown in FIG. 5 where the automobile surface protector 1 is mounted towards the forward end of the cargo area 70. The inner tube 72 and outer tube 74 of the telescopic mounting assembly are extended so that the feet engage the walls of the wider section of the cargo area 70. The protective sheets 76, 78 are unwound to primarily cover the automobile surface such as a rear or front bumper 80.

In another embodiment of the present invention, the protective sheets are made from a heavy less flexible material such as rubber and extend from the slides to cover the surface of the automobile. In this embodiment, the protector is used in substantially the same manner as the previous embodiment with the exception that the protective sheets are not wound about the roller assembly for storage.

The foregoing describes only certain embodiments of the invention and modifications can be made without departing from the scope of the invention as defined in the following claims.

1. An automobile surface protector for mounting in a vehicle cargo area, the protector comprising:
a roller assembly formed by an outer tubular slide and an inner tubular slide received in said outer slide so that the length of the roller assembly can be selectively adjusted,
a first flexible protective sheet attached to said outer slide, and a second flexible protective sheet attached to said inner slide,
whereby the first flexible sheet and second flexible sheet slide with respect to each other during adjustment of the length of the roller assembly to provide corresponding adjustment of the width covered by said first flexible sheet and said second flexible sheet,
a mounting assembly to mount said outer slide and said inner slide, said mounting assembly including feet at each end of the mounting assembly to respectively bear against opposing walls of a vehicle cargo area.

2. The surface protector according to claim 1, wherein said outer slide and said inner slide each includes a longitudinal slot into which respective edges of said first and said second sheet are fastened.

3. The surface protector according to claim 2, wherein the slots are nested adjacent to each other and do not extend beyond the surface of said outer slide, so that said protective sheets can be rolled smoothly around the roller assembly when not in use.

4. The surface protector according to claim 1, wherein said outer slide includes a longitudinal opening through which said second sheet extends from said inner slide.

5. The surface protector according to claim 1, wherein the mounting assembly includes two tubular components, one tubular component received within the other tubular component so that the length of the mounting assembly can be adjusted independently of the slides.

6. The surface protector according to claim 5, further comprising a lock by which said two tubular components are locked relative to one another.
